(19) United States
(12) Patent Application Publication
(10) Pub. No.: US 2016/0138883 A1
(43) Pub. Date: May 19, 2016

(54) ELECTRIC HYDRAULIC BORE CLEANER SYSTEM

(71) Applicants: Scott Huffman, Delaware, OH (US); Mark Huffman, Delaware, OH (US)

(72) Inventors: Scott Huffman, Delaware, OH (US); Mark Huffman, Delaware, OH (US)

(21) Appl. No.: 14/941,491

(22) Filed: Nov. 13, 2015

Related U.S. Application Data
(60) Provisional application No. 62/079,703, filed on Nov. 14, 2014.

(51) Int. Cl. F41A 29/00; B08B 9/053; B08B 9/04

(52) U.S. Cl. CPC F41A 29/00; B08B 9/04; B08B 9/053

(57) ABSTRACT

A bore cleaner for a tank that literally crawls through the bore of the tank, and in the process of crawling through the bore, cleans the interior walls of the bore with very little user intervention or monitoring. The bore cleaner extends and retracts as it moves through the bore of the tank, and as it extends and retracts, brushes on the present invention rub against the inside of the bore of the tank and remove debris. When the bore cleaner reaches one end of the bore of the tank, slight user intervention is necessary to reverse the direction of the brushes on the bore cleaner.

This application claims the benefit of U.S. Provisional Patent Application No. 62/079,703, filed Nov. 14, 2014, entitled ELECTRIC HYDRAULIC BORE CLEANER SYSTEM, the contents of which is incorporated herein by reference.

### BACKGROUND

A. Field of Invention

This invention pertains to the art of methods and apparatuses related to weapon barrels, and more specifically to methods and apparatus related to cleaning the bores of relatively large weapon barrels.

B. Description of the Related Art

Many weapons include a barrel having a bore through which an object is fired or propelled. After repeated firings, the bore becomes dirty and needs to be cleaned. While weapon barrels of all sizes need to be cleaned, the methods and apparatuses used to clean relatively small bores, such as rifle barrels, are generally quite different from the methods and apparatuses used to clean relatively large bores, such as military tank or Howitzer barrels.

Bore cleaning devices, sometimes called bore cleaners or bore brushes, for relatively large bores are known. One known bore cleaning device is described in U.S. patent application Ser. No. 11/458,014 titled BORE BRUSH and published as Pub. No.: US 2009/0277474 on Nov. 12, 2009, which is hereby incorporated by reference in its entirety. While many known bore cleaning devices work well for their intended purposes, improvements are desirable.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective side view of a military tank having a barrel with a bore that may use a bore cleaner system according to some embodiments of this invention.

FIG. 2 is an assembly view of a bore cleaner system according to some embodiments of this invention.

FIG. 3 is a side view of a brush cylinder assembly according to some embodiments of this invention.

FIG. 4 is a side view of the brush cylinder assembly of FIG. 3 but shown disassembled.

FIG. 5 is a perspective side view of a brush.

FIG. 6 is a side view of the brush shown in FIG. 5.

FIG. 7 is a top perspective view of a motor pump assembly according to some embodiments of this invention.

FIG. 8 is a top perspective view of miscellaneous parts that may be used with some embodiments of this invention.

FIG. 9 is a front perspective view of a barrel bore being prepared.

FIG. 10 is a side perspective view of a brush cylinder assembly initially inserted into a barrel bore.

FIG. 11 is a side perspective view of a brush cylinder assembly fully inserted into a barrel bore.

FIG. 12 is a front perspective view of a storage container according to some embodiments of this invention.

FIG. 13 is a top perspective view of the storage container of FIG. 12 but with the lid opened and components visible.

### DETAILED DESCRIPTION OF EMBODIMENTS OF THE INVENTION

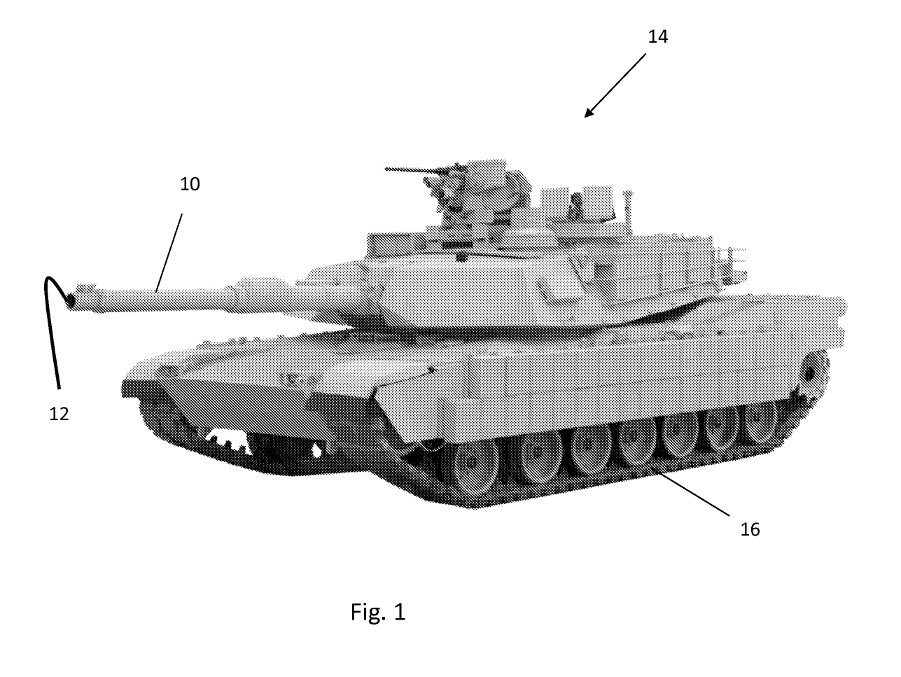

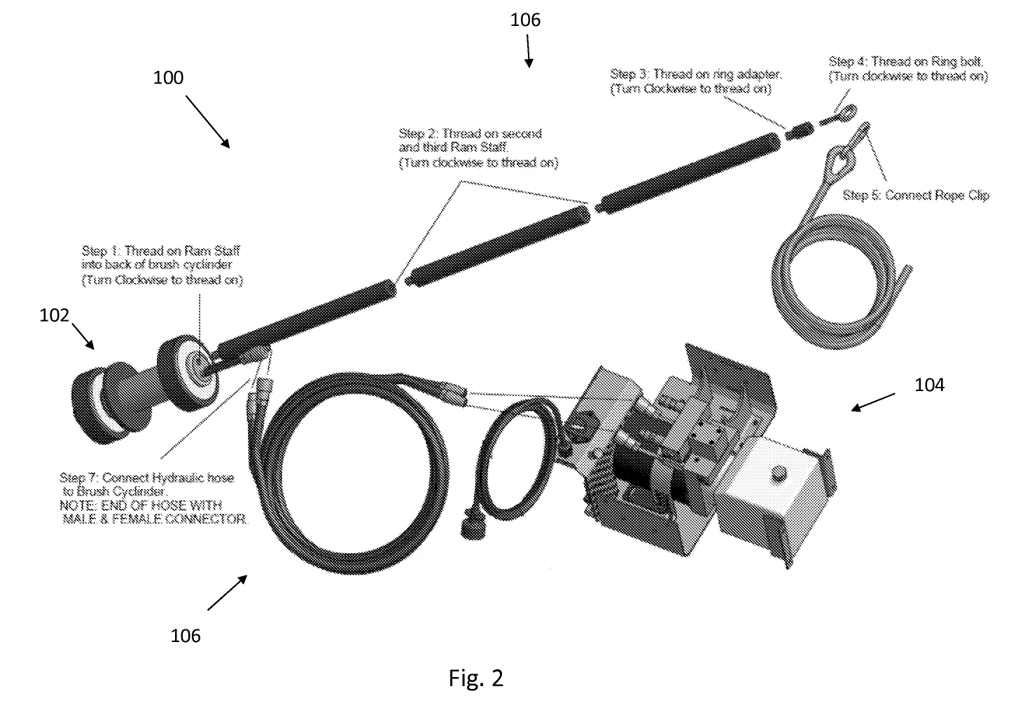

Referring now to the drawings wherein the showings are for purposes of illustrating embodiments of the invention only and not for purposes of limiting the same, and wherein like reference numerals are understood to refer to like components, FIG. 1 shows a weapon including a barrel 10 having a bore 12 that fires or propels an object being fired and that can be cleaned using a bore cleaner system 100 (see FIG. 2) according to embodiments of this invention. While the barrel 10 shown is mounted to a military vehicle 14 having a track system 16 used in a known manner to move the military vehicle 14 from place to place, it should be noted that the military vehicle 14 is exemplary only as the bore cleaner system 100 of this invention may be used with any barrel including barrels on other vehicles, barrels not on a vehicle, and non-weapon barrels as well.

As shown in FIG. 2, the bore cleaner system 100 may be thought of as having three categories of components: a brush cylinder assembly 102, a motor pump assembly 104 and miscellaneous parts 106. These components will now be described in succession.

With reference now to FIGS. 1-6, the brush cylinder assembly 102 may include a cylinder 108, a front (opposite the hydraulic connection lines) brush 110 and a rear (connection line end) brush 112. The cylinder 108 may be a fluid operated cylinder, such as a hydraulic cylinder, having power lines, such as hydraulic lines, 114, 114, operated as will be discussed further below. The cylinder 108 may have a have a mid-section 122 and first and second ends 124, 126 extending from opposite ends of the mid-section 122. The mid-section 122 may have an outer surface with threads on its opposite the hydraulic connection lines end, as shown. The first end 124 may have a smaller outside diameter than the mid-section 122 and the hydraulic connection lines 114, 114 may extend from the first end 124, as shown. The outer surface of the distal end (away from the mid-section 122) of the first end 124 may include threads, as shown. The second end 126 may also have a smaller outside diameter than the mid-section 122 and may have a threaded opening at its distal (away from the mid-section 122) end. The second end 126 may have a shoulder 138 with an outside diameter larger than the rest of the second end 126.

The second end 126 may be a piston rod having a piston (not shown but of any type chosen by a person of skill in the art) positioned within the cylinder 108. The piston rod 126 can be moved relative to the cylinder 108 under fluid pressure. The operation may be similar to the operation described in previously incorporated US 2009/0277474.

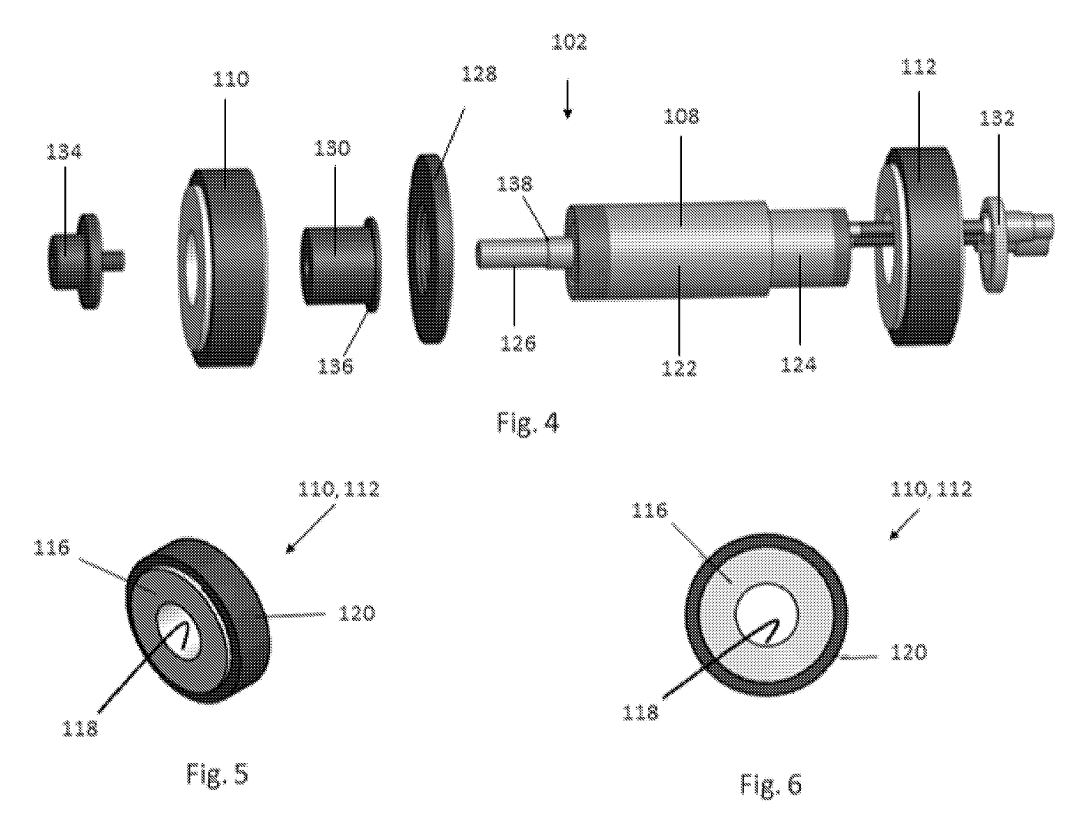

With reference now to FIGS. 4-6, the brushes 110, 112 may have cleaning surfaces 120 used to clean the bore. In one embodiment, the brushes 110, 112 may be cylindrical in shape having an inner hub 116 with a radially inward and centrally located opening 118 and a radially outward bristle ring defining the cleaning surface 120. The opening 118 may have a circular perimeter, as shown. The brushes 110, 112 can be sized and formed of materials appropriate for their intended use. In one embodiment, the hub 116 is formed of Polyvinyl Chloride (PVC) and the bristle ring 120 is formed of nylon bristles. For the embodiment shown, the brushes 110, 112 are identical and thus interchangeable. In other embodiments, the brushes are not identical and may be uniquely designed. The brush cylinder assembly 102 may also include a spacer 128 having a threaded opening, a bushing 130 having an opening and a flange 136, a retaining ring 132 having a threaded opening, and a retaining nut 134 having a connection shaft with a threaded outer surface.

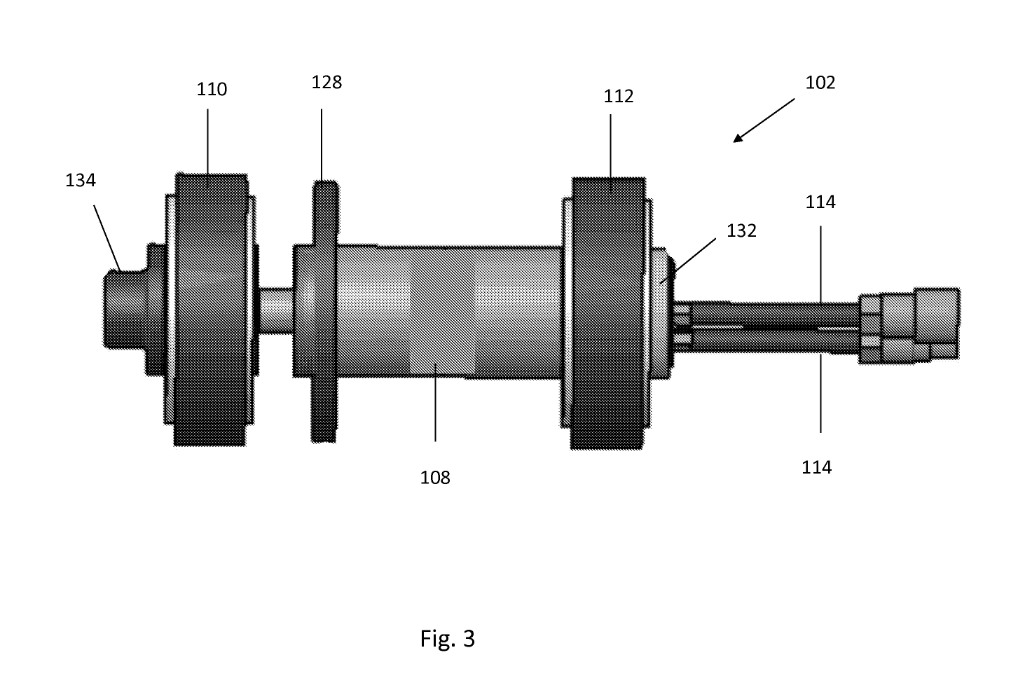

With reference now to FIGS. 3-6, to assemble the brush cylinder assembly 102, the rear brush 112 may be slid over the connection lines 114 and over the first end 124 of the cylinder (both are received within the opening 118). The retaining ring 132 may then be slid over the connection lines 114 and its threaded opening may be engaged with the threads on the distal end of the first end 124 (by rotating the retaining ring 132 with respect to the cylinder 108) to secure the rear brush 112 to the cylinder 108. The spacer 128 may be slid over the second end 126 (which is received within the spacer opening) and its threaded opening may be engaged with the threads on the mid-section 122 (by rotating the spacer 128 with respect to the cylinder 108) to secure the spacer 128 to the cylinder 108.

With continuing reference to FIGS. 3-6, the bushing 130 may be slid over the first end 126 (which is received within the bushing opening) until the bushing 130 contacts the shoulder 138. The front brush 110 may then be slid over the bushing 130 (which is received within the opening 118) until the front brush 110 contacts the flange 136. The retaining nut 134 may then be positioned with its threaded connection shaft extending through the front brush 110 opening and the bushing 130 opening until it engages the threaded opening in the first end 126 (by rotating the retaining nut 134 with respect to the cylinder 108) to secure the front brush 110 to the cylinder 108.

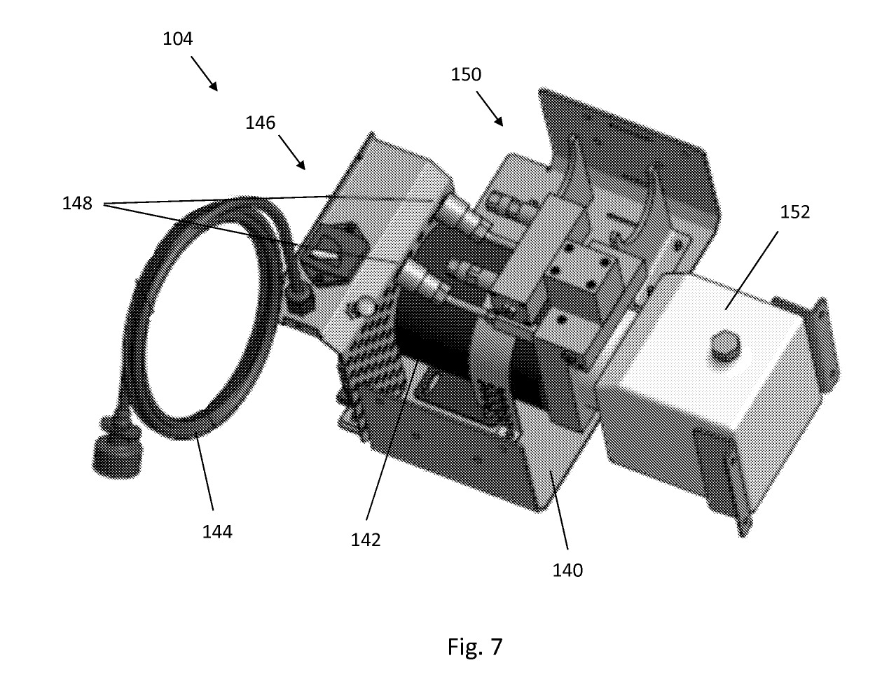

With reference now to FIGS. 2 and 7, the motor pump assembly 104 may include a housing or frame 140 and a motor/pump 142 supported to the frame 140. The motor/pump 142 may be of any type chosen with the sound judgment of a person of skill in the art to provide the required fluid pressure, such as hydraulic fluid pressure. A liquid tank 152, may be filled with an appropriate fluid, such as hydraulic oil, and may also be supported to the frame 140. A power cable 144 may be provided to provide for a power source, though other power sources chosen with the sound judgment of a person of skill in the art may be used. In one specific embodiment that is ideal for military use, the power cable 144 is a NATO power cable. Non-limiting examples of NATO power cables that may be used with this invention are disclosed in U.S. Pat. Nos. 7,364,469 and 8,545,256 each titled ELECTRICAL CONNECTOR FOR USE WITH NATO EQUIPMENT and incorporated herein by reference in their entirety. Controls 146 may be provided to control the motor/pump 142. Fluid connectors 148, 148 may extend from the motor/pump 142. The frame 140 may include an area 150 to which the brush cylinder assembly 102 may be supported.

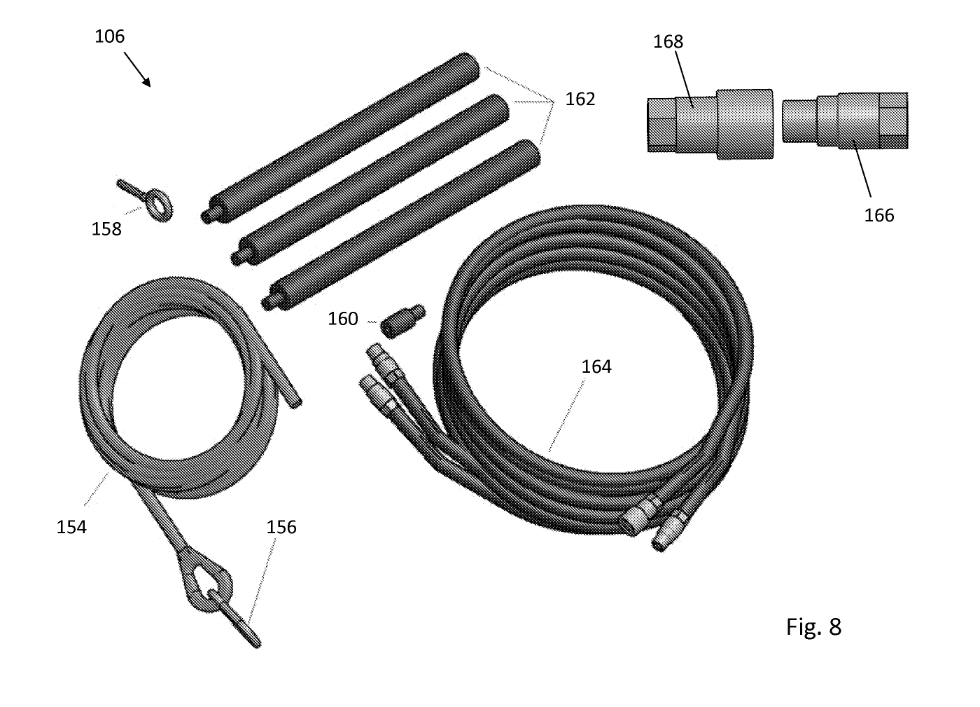

With reference now to FIGS. 2 and 8, miscellaneous parts 106 that may be used are shown. The miscellaneous parts 106 may include a rope 154 having a rope clasp 156, an eye bolt 158 and an eyelet adapter 160. Ram segments 162 (three shown) and a pair of hydraulic hoses 164 may also be provided. The ram segments 162 may have male fittings on one end and female fittings on the opposite end to simplify interconnection. Also shown are male and female house couplers 166, 168 which may be used to interconnect the hydraulic hoses 166 to the hydraulic connectors 148 and/or to the hydraulic connection lines 114 (see FIG. 3).

With reference now to FIG. 2, assembly of the bore cleaner system 100 will now be described. First, a ram segment 162 may be attached to the end of the brush cylinder assembly 102 such as by threading the male end of the ram segment 162 into an opening formed on the brush cylinder assembly 102, as shown. Next, additional ram segments 162 may be attached to each other, male end to female end, as desired to create the length necessary to fit the length of the bore 12 to be cleaned. The eyelet adapter 160 may then be attached to the distal most end of the ram segments and the eye bolt 158 may be attached to the eyelet adapter 160. The rope clasp 156, connected to one end of the rope 154, may then be attached to the eyelet adapter 160. The hydraulic hoses 164 may then be attached at one end to the hydraulic connectors 148, 148 at the motor/pump 142 and at their other ends to the hydraulic connection lines 114, 114 on the brush cylinder assembly 102.

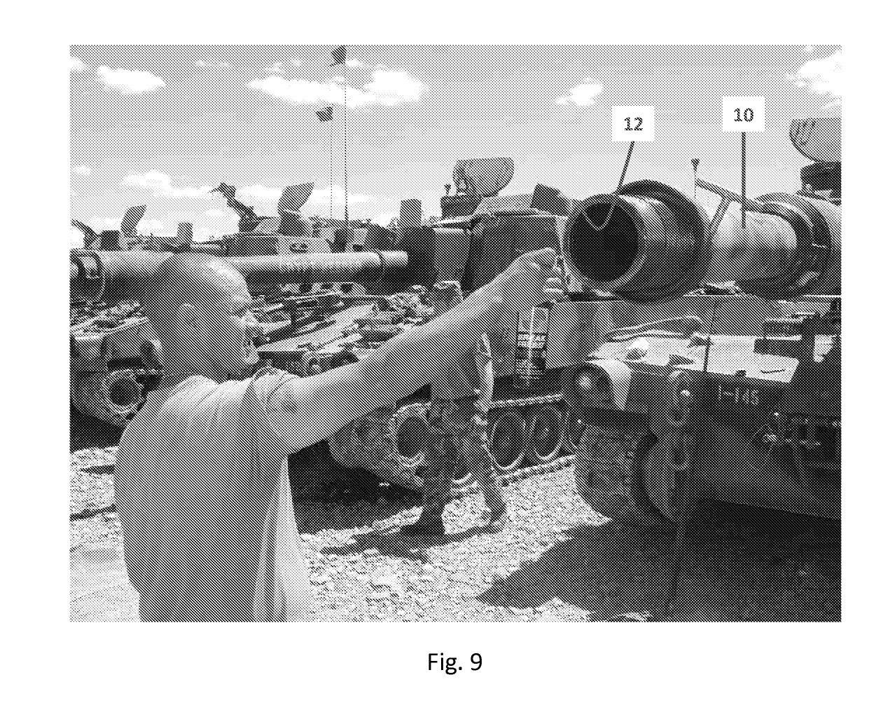

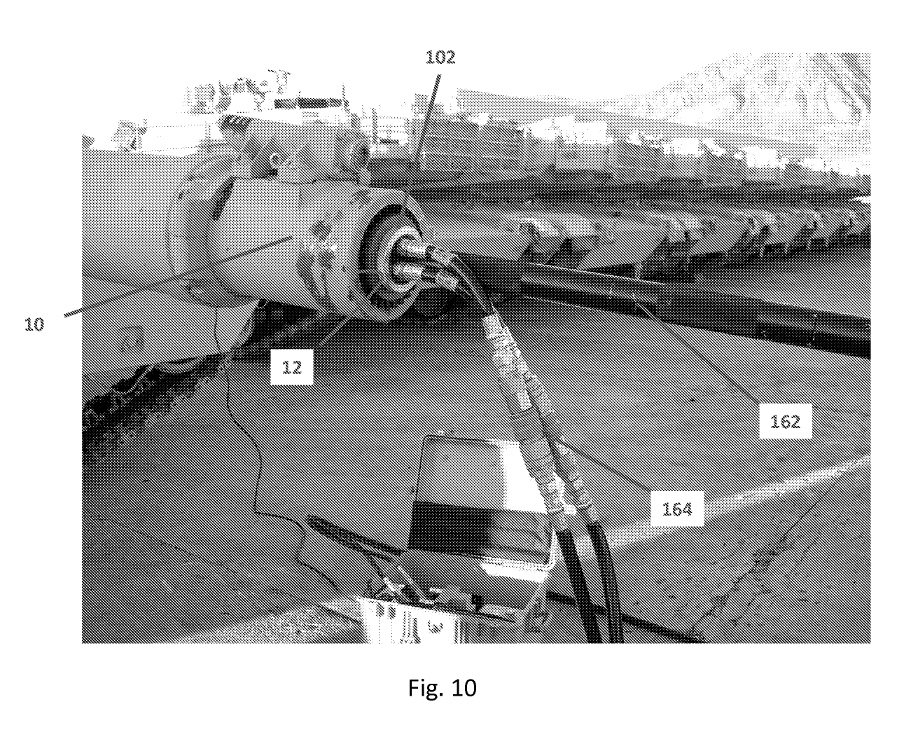

With reference now to all the FIGURES, operation of the bore cleaner system 100 will now be described. First, as shown in FIG. 9, a thin layer of oil may be applied to the bore 12 at the end of the barrel 10 to which the brush cylinder assembly 102 will be inserted. If possible, the bore 12 may be lubricated at both ends of the barrel 10. A thin layer of oil may also applied to the bristle rings 120. Next, as shown in FIG. 10, the brush cylinder assembly 102 is inserted into the end of the bore 12 front brush 110 in first. The full length of the brush cylinder assembly 102 may be inserted into the bore 12. The ram segments 162 and hydraulic hoses 164 will extend out of the bore 12, as shown.

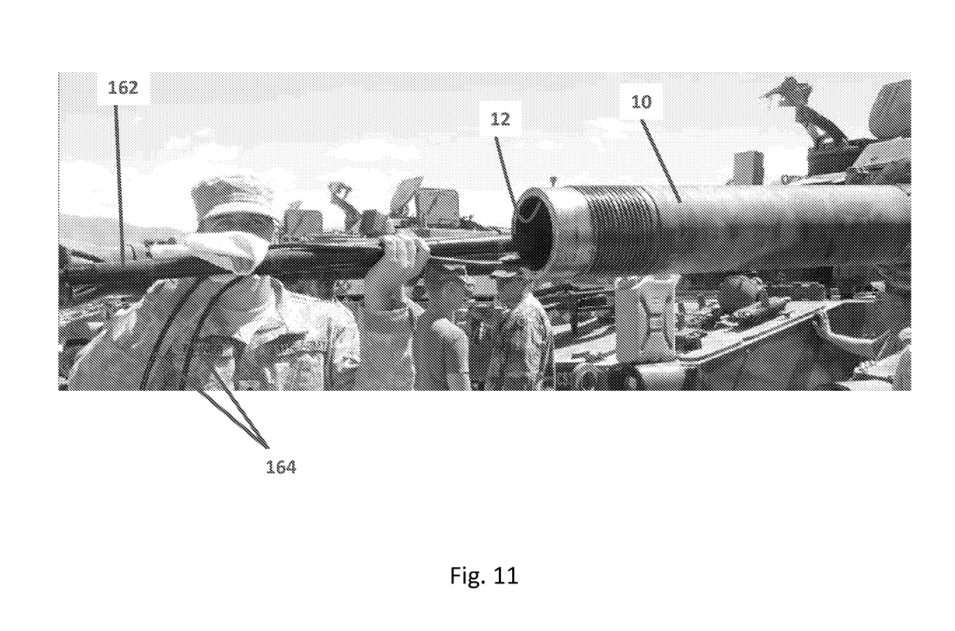

With reference now to FIGS. 2 and 7, the power cable 144 may be connected between a suitable power source and the motor pump assembly 104. If the power cable 144 is a NATO power cable, the source may be, for a non-limiting example, a NATO/Slave receptacle in a military vehicle. Once the bore cleaner system 100 has begun running, with reference now to FIG. 11, the front brush 112 will begin to plunge into the bore 12, similar to the operation described in previously incorporated US 2009/0277474, pulling the brush cylinder assembly 102 down the barrel bore 12. All the operator has to do is make sure that the rope 154, ram segments 162 and hydraulic hoses 164 do not tangle. When the brush cylinder assembly 102 reaches the opposite end of the bore 12, it will stop plunging forward. To reverse the brush cylinder assembly 102, the operator simply gives the rope 154 a firm tug and the system will reverse direction and crawl back toward the first end of the bore 12 (the end it was initially inserted into). As the brush cylinder assembly 102 moves toward the operator, the operator may lightly pull on the hoses 164 and rope 154. This small force will prevent the brush cylinder assembly 102 from running over the hoses 164 and rope 154 inside the bore 12. Just prior to the rear brush 112 reaching the end of the bore 12, the operator may shut off the master switch of the controls 146 and secure the ram segments 162 to prevent the brush cylinder assembly 102 from falling out of the bore 12 when it returns. This cycle may be repeated, if necessary, in order to adequately clean the bore 12 and apply a thin layer of oil.

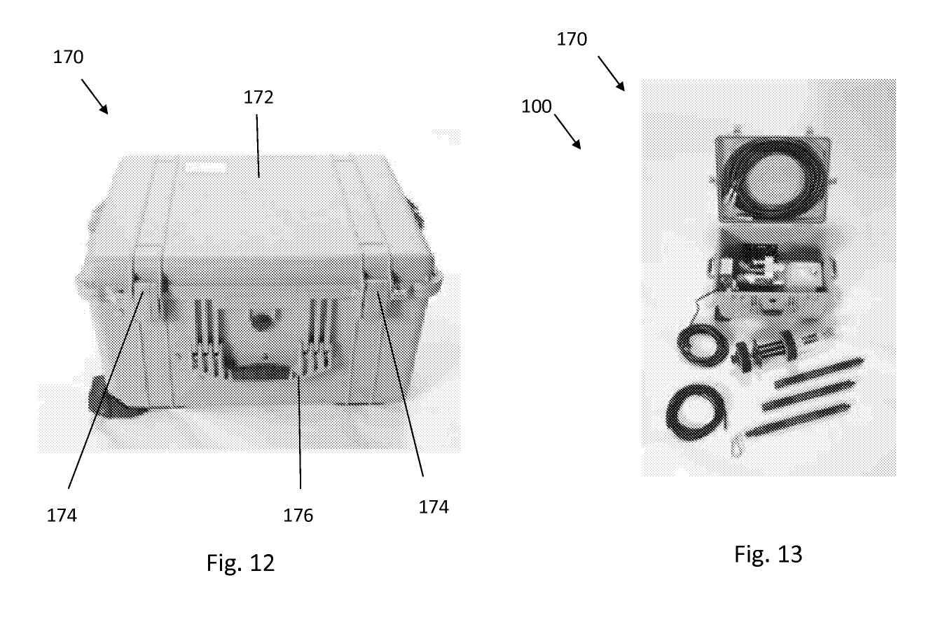

With reference now to FIGS. 12-13, to make transportation of the bore cleaner system 100 easy, a storage container 170 may be provided. FIG. 12 shows the container 170 with the lid 172 closed and secured by a pair of manually adjustable latches 174 and with a handle 176 pivotally attached to the container 170. FIG. 13 shows the storage container 170 with the lid 172 open and the various components now visible and partially removed from the container 170.

While the particular performance characteristics of the bore cleaner system 100 can be any chosen with the sound judgment of a person of skill in the art, below is a list of system specifications according to one non-limiting embodiment:
Operators: 1-2 Person (depending on ability)
Stroke: 3 inches (7.62 cm)
Velocity: 3 inches in 75 milliseconds (7.62 cm/75 msec)
Input voltage: 24-30 VDC
Peak current rating: 70 amps
Continuous current: 25-36 amps
Component Weight (lbs.): 130 lbs (in container) (58.5 kg)
Dimensions (container): 24.81″ L×19.37″ W×13.87″ D (L 63 cm×W 49 cm×D 35 cm)
Hose Length: 25 Ft. (7.6 meters)
Oil specification: Dexron/Mercon III (High temp. automatic transmission fluid)
Oil Capacity: 1 gallon—½ reservoir should be empty (3.8 liters)
DC Motor HP: 5 HP
Force: 1.5 Tons (1500 kg)
Operating Temperature: −20 degrees C. to +70 degrees C.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A bore cleaner system comprising:
a brush cylinder assembly comprising:
a fluid operated cylinder;
a front brush having a cleaning surface;
a rear brush having a cleaning surface;
a power connection;
a motor pump assembly comprising:
a frame;
a liquid tank supported to the frame;
a motor/pump supported to the frame;
controls that are operable to control the motor/pump;
wherein the bore cleaner system is operable: (1) to move within an associated bore in a first direction to clean the bore with the cleaning surfaces of the front and rear brushes; and, (2) to move within the associated bore in a second direction, opposite the first direction, to clean the bore with the cleaning surfaces of the front and rear brushes.
